(19) United States
(12) Patent Application Publication
(10) Pub. No.: US 2007/0189231 A1
(43) Pub. Date: Aug. 16, 2007

(54) Method and system for implementing a bufferless HARQ processor

(76) Inventors: Li Fung Chang, Holmdel, NJ (US); Simon Baker, San Diego, CA (US); Uri Landau, San Diego, CA (US); Wei Luo, Marlboro, NJ (US); Pieter Roux, San Diego, CA (US)

Correspondence Address: MCANDREWS HELD & MALLOY, LTD, 500 WEST MADISON STREET, SUITE 3400, CHICAGO, IL, 60661, US

(21) Appl. No.: 11/353,818

(22) Filed: Feb. 14, 2006

(51) Int. Cl. H04B 7/216

(52) U.S. Cl. 370/335

(57) ABSTRACT

Certain aspects of a method and system for handling signals in a communication system are disclosed. Aspects of one method may include mapping of at least a portion of a plurality of information bits in a received HSDPA bitstream to particular memory addresses without buffering a portion of the plurality of information bits during hybrid automatic request (HARQ) processing. The portion of the plurality of information bits may be sliced and quantized to determine the quantized value of the soft bits and the corresponding memory addresses. The processing of the plurality of information bits may be partitioned into a functional data processing path and a functional address processing path.

### CROSS-REFERENCE TO RELATED APPLICATIONS/INCORPORATION BY REFERENCE

This application makes reference to:

U.S. application Ser. No. 11/141,478 (Attorney Docket No. BP 4630) filed on May 31, 2005;

U.S. application Ser. No. 11/140,805 (Attorney Docket No. BP 4631) filed on May 31, 2005;

U.S. application Ser. No. 11/142,213 (Attorney Docket No. BP 4632) filed on Jun. 1, 2005;

U.S. application Ser. No. ______ (Attorney Docket No. 16879US01) filed on even date herewith;

U.S. application Ser. No. ______ (Attorney Docket No. 17261US01) filed on even date herewith; and

U.S. application Ser. No. ______ (Attorney Docket No. 17266US01) filed on even date herewith.

Each of the above stated applications is hereby incorporated herein by reference in its entirety.

### FIELD OF THE INVENTION

Certain embodiments of the invention relate to high-speed wireless communication. More specifically, certain embodiments of the invention relate to a method and system for implementing a bufferless hybrid automatic request (HARQ) processor.

### BACKGROUND OF THE INVENTION

The Universal Mobile Telecommunications System (UMTS) in its third generation (3G) is intended to provide a wide range of services including telephony, paging, messaging, Internet and broadband data. The International Telecommunication Union (ITU) started the process of defining the standard for third generation systems, referred to as International Mobile Telecommunications 2000 (IMT-2000). In Europe, European Telecommunications Standards Institute (ETSI) was responsible for the UMTS standardization process. In 1998, the Third Generation Partnership Project (3GPP) was formed to continue the technical specification work. The 3GPP has five main UMTS standardization areas: radio access network, core network, terminals, services and system aspects and GSM EDGE radio access network (GERAN).

The 3G Radio Access Technology (UTRAN) is based on the wideband code-division multiple-access (WCDMA) technology. The 3G/UMTS has been specified as an integrated solution for mobile voice and data with wide area coverage. The 3G/UMTS in its initial phase offers theoretical bit rates of up to 384 kbps in high mobility situations, rising as high as 2 Mbps in stationary/nomadic user environments and has been universally standardized via the Third Generation Partnership Project (www.3gpp.org) by using globally harmonized spectrum in paired and unpaired bands.

The 3G/UMTS networks using WCDMA technology are operating commercially worldwide in Asia, Europe, US and Japan. It offers mobile operators significant capacity and broadband capabilities to support greater numbers of voice and data customers, especially in urban centers with higher data rates. The symmetry between uplink and downlink data rates when using paired frequency division duplex (FDD) spectrum indicates that 3G/UMTS is ideally suited for applications such as real-time video telephony in contrast with other technologies such as asymmetric digital subscriber line (ADSL), where there is a pronounced asymmetry between uplink and downlink throughput rates.

The throughput speeds of the WCDMA Radio Access Network (RAN) may be further increased in the future. High speed downlink packet access (HSDPA) and high speed uplink packet access (HSUPA) technologies are already standardized and are undergoing network trials with operators in the Far East and North America. These technologies may play an instrumental role in positioning 3G/UMTS as a key enabler for true ‘mobile broadband’ by promising theoretical downlink speeds as high as 14.4 Mbps and 5.8 Mbps uplink, for example. The 3G/UMTS will offer enterprise customers and consumers all the benefits of broadband connectivity whilst on the move by offering data transmission speeds of the same order of magnitude as today's Ethernet-based networks that are an ubiquitous feature of the fixed-line environment. HSDPA implementations may include adaptive modulation and coding (AMC), multiple-input multiple-output (MIMO), hybrid automatic request (HARQ), fast cell search, and advanced receiver design.

The HSDPA technology is an Internet protocol (IP) based service, oriented for data communications, which adapts WCDMA to support data transfer rates up to 14.4 megabits per second (Mbits/s). Developed by the 3GPP group, the HSDPA technology achieves higher data rates through a plurality of methods. For example, many transmission decisions may be made at the base station level, which is much closer to the user equipment as opposed to being made at a mobile switching center or office. These may include decisions about the scheduling of data to be transmitted, when data is to be retransmitted, and assessments about the quality of the transmission channel. The HSDPA technology utilizes variable coding rates. The HSDPA technology supports 16-level quadrature amplitude modulation (16-QAM) over a high-speed downlink shared channel (HS-DSCH), which permits a plurality of users to share an air interface channel.

Given the nature of wireless communication, transmitted packets may be lost or may not be received in a manner in which they can be adequately demodulated and/or decoded. Accordingly, retransmission of information may be required to ensure reliable communication over a wireless link. Although various mechanisms are utilized for retransmission, some require significant processing overhead, which may not be suitable for mobile communication devices that have fairly limited processing power and power constraints.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method for implementing a bufferless HARQ processor, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A illustrates an exemplary HSDPA distributed architecture that may be utilized in connection with an embodiment of the invention.

FIG. 1B is a block diagram that illustrates functional partitioning of the transmit side of HSDPA bit processing, which may be utilized in connection with an embodiment of the invention.

FIG. 2 is a block diagram that illustrates exemplary partitioning of the physical layer of a HSDPA receiver into a plurality of functional blocks, which may be utilized in connection with an embodiment of the invention.

FIG. 3 is a high-level block diagram illustrating an exemplary data processing path for a received HSDPA signal, in accordance with an embodiment of the invention.

FIG. 4 is a block diagram of an exemplary slicer/quantizer block, in accordance with an embodiment of the invention.

FIG. 5 is a block diagram of an exemplary hybrid automatic request (HARQ) processor, in accordance with an embodiment of the invention.

FIG. 6A is a block diagram of an exemplary HARQ processor, in accordance with an embodiment of the invention.

FIG. 6B is an exemplary block diagram illustrating the implementation of a bufferless HARQ processor, in accordance with an embodiment of the invention.

FIG. 6C is an exemplary block diagram of a bit collection buffer, in accordance with an embodiment of the invention.

FIG. 7 is a block diagram of an exemplary HSDPA turbo decoding module (HTDM), in accordance with an embodiment of the invention.

FIG. 8 is a block diagram of bit level processor (BLP) architecture, in accordance with an embodiment of the invention.

FIG. 9 is a flowchart illustrating implementation of a bufferless HARQ processor, in accordance with an embodiment of the invention.

### DETAILED DESCRIPTION OF THE INVENTION

Certain aspects of a method and system for handling signals in a communication system may include mapping at least a portion of a plurality of information bits in a received HSDPA bitstream to particular memory addresses without buffering a portion of the plurality of information bits during hybrid automatic request (HARQ) processing. The portion of the plurality of information bits may be sliced and quantized to determine the quantized value of the soft bits and the corresponding addresses. The processing of the plurality of information bits may be partitioned into a functional data processing path and a functional address processing path.

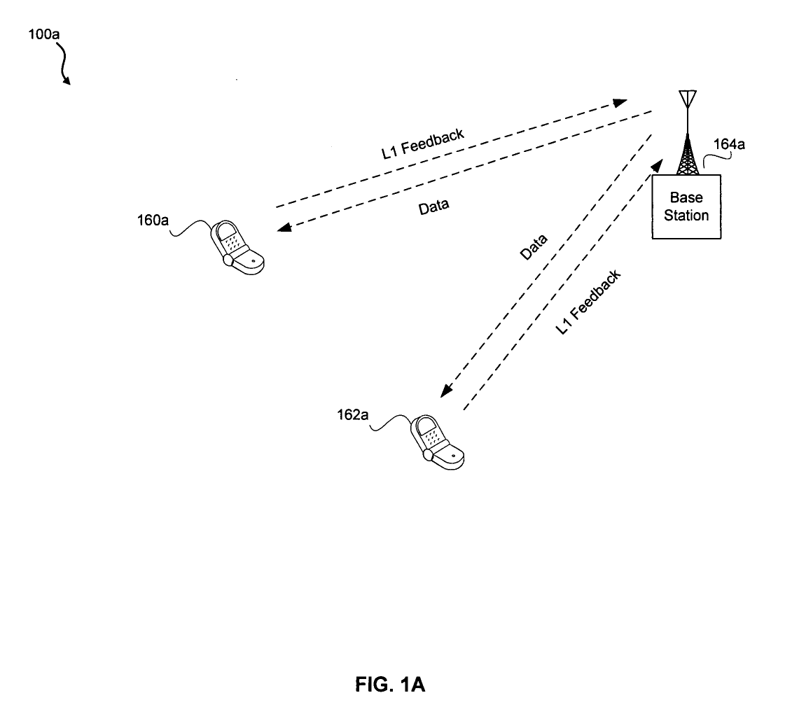

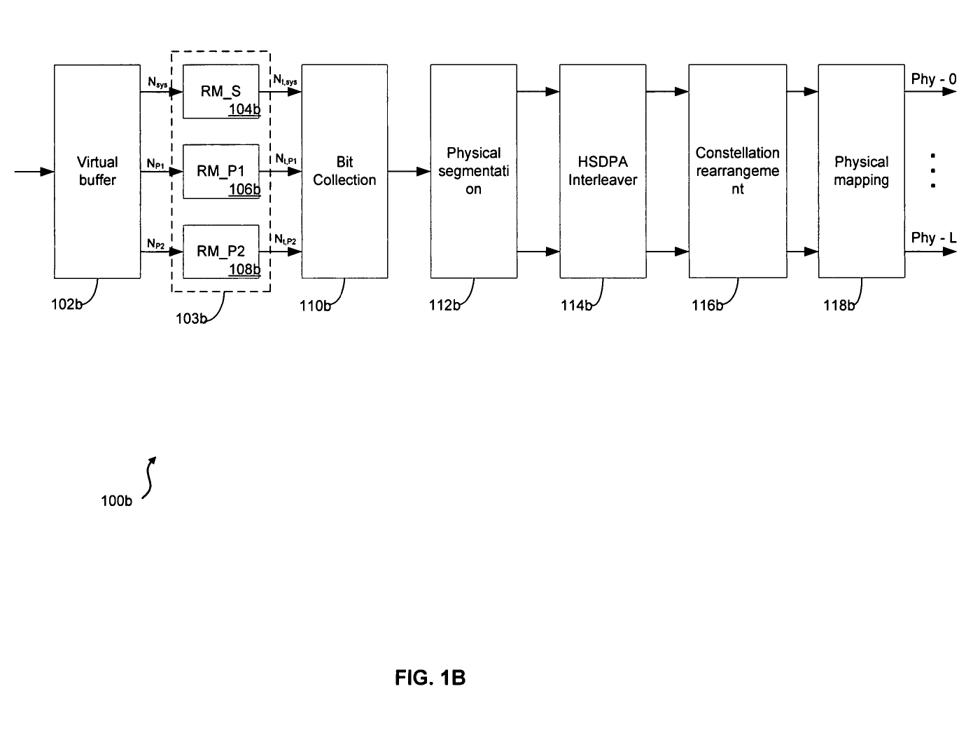

FIG. 1A illustrates an exemplary HSDPA distributed architecture that may be utilized in connection with an embodiment of the invention. Referring to FIG. 1A, there is shown terminals 160a and 162a and a base station (BS) 164a. The terminals 160a and 162a may comprise suitable logic, circuitry and/or code to communicate with the BS 164a.

HSDPA is built on a distributed architecture that achieves low delay link adaptation by placing key processing at the BS 164a and thus closer to the air interface as illustrated. Accordingly, the MAC layer at the BS 164a is moved from Layer 2 to Layer 1, which implies that the systems may respond in a much faster manner with data access. Fast link adaptation methods, which are generally well established within existing GSM/EDGE standards, include fast physical layer (L1) retransmission combining and link adaptation techniques. These techniques may deliver significantly improved packet data throughput performance between the mobile terminals 160a and 162a and the BS 164a.

The HSDPA technology employs several important new technological advances. Some of these may comprise scheduling for the downlink packet data operation at the BS 164a, higher order modulation, adaptive modulation and coding, hybrid automatic repeat request (HARQ), physical layer feedback of the instantaneous channel condition, and a new transport channel type known as high-speed downlink shared channel (HS-DSCH) that allows several users to share the air interface channel.

HARQ is an advanced retransmission strategy, which allows possible retransmissions directly at the physical and medium access control (MAC) layer, without involving higher layer mechanisms and hence reducing the delay. When deployed; HSDPA may co-exist on the same carrier as the current WCDMA and UMTS services, allowing operators to introduce greater capacity and higher data speeds into existing WCDMA networks. HSDPA replaces the basic features of WCDMA, such as variable spreading factor and fast power control, with adaptive modulation and coding, extensive multicode operation, and fast and spectrally efficient retransmission strategies.

FIG. 1B is a block diagram that illustrates functional partitioning of the transmit side of HSDPA bit processing, which may be utilized in connection with an embodiment of the invention. Referring to FIG. 1B, there is shown a virtual buffer block 102b, a second rate matching block 103b, a bit collection block 110b, a physical segmentation block 112b, a HSDPA interleaver block 114b, a constellation rearrangement block 116b, and a physical mapping block 118b. The second rate matching block 103b may comprise a plurality of rate matching blocks, for example, a systematic rate matching stream (RM_S) block 104b, a parity-1 rate matching stream block 106b, and a parity-2 rate matching stream block 108b.

The virtual buffer 102b may comprise suitable logic, circuitry and/or code that may be enabled to receive a bitstream N_{TTI} and generate a plurality of bitstreams, a systematic bitstream Nsys, a parity-1 bitstream Np1 and a parity-2 bitstream Np2. The Nsys bitstream may be passed through a systematic rate matching (RM_S) block 104b to generate a bitstream Nt,sys. The Np1 bitstream may be passed through a parity-1 rate matching (RM_P1) block 106b to generate a bitstream Nt,p1. The Np2 bitstream may be passed through a parity-1 rate matching (RM_P2) block 108b to generate a bitstream Nt,p2. This process maps the three stream addresses' range to a range dictated by the hardware (HW) symbol rate. The second rate matching block 103b may enable bit puncturing by omitting bits by predefined schemes, for example, a systematic rate matching stream, a parity-1 rate matching stream, and a parity-2 rate matching stream. The second rate matching block 103b may be enabled to match the required fixed rate dictated by the hardware. The three rate matching processes may be parameterized by enabling the UE to re-map the received stream of bits to their original location.

The bit collection block 110b may comprise suitable logic, circuitry and/or code that may enable writing of the three bitstreams column wise into a square array with 3 predefined domains for the three bit types, for example, systematic, parity-1 and parity-2. The bitstreams may be read full column-wise, for example, 2 rows in the case of QPSK and 4-rows in the case of QAM16. Each column may represent a symbol pair or four bits, for example. The physical segmentation block 112b may enable partitioning of the single symbol stream into L streams, where L=1 . . . 15. The first 480 symbol pairs or four-bit sets may be associated with physical channel (Phy-Ch) 1, for example, the second 480 symbol pairs or four-bit sets may be associated with Phy-Ch 2, for example, and so on. Each of the 480 symbol pairs or four-bit sets may be passed through the HSDPA interleaver block 114b. In the case of QAM modulation, each of the 4 bits may be passed through the constellation rearrangement block 116b for further mapping. The physical mapping block 118b may be enabled to assign each Phy-Ch to the 15 OVSF codes, for example, and 2 or 4 bits may be assigned to the I and Q values.

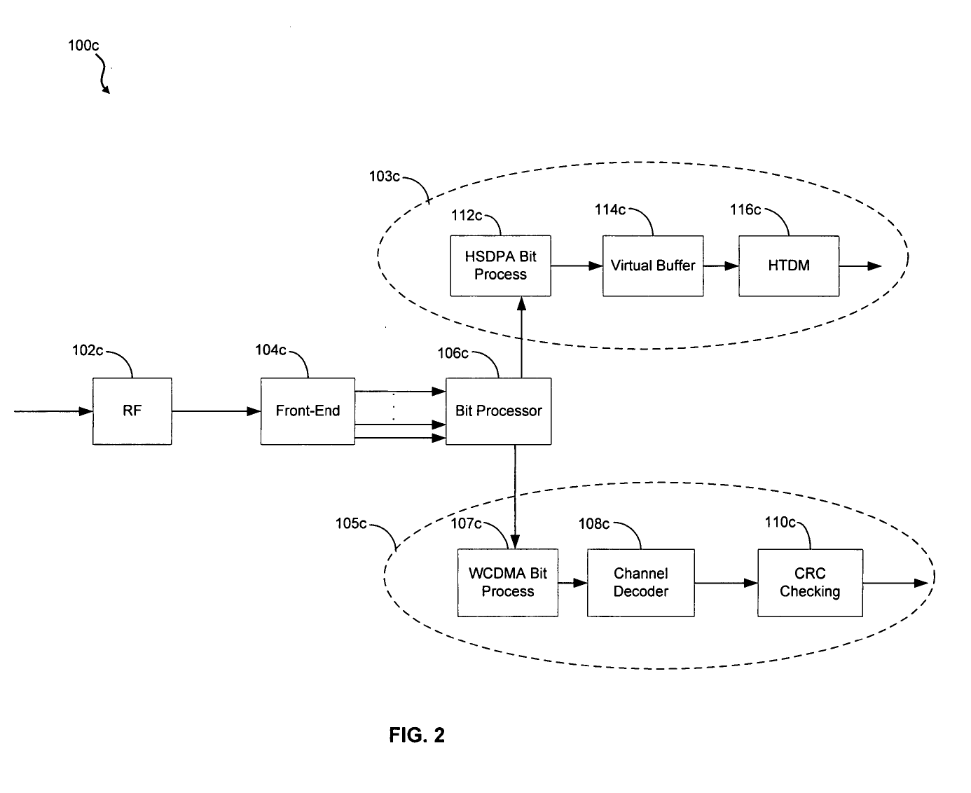

FIG. 2 is a block diagram that illustrates exemplary partitioning of the physical layer of a HSDPA receiver into a plurality of functional blocks, which may be utilized in connection with an embodiment of the invention. Referring to FIG. 2, a physical layer of a WCDMA based mobile technology, also known as user equipment (UE) 100c may comprise a RF block 102c, a front-end block 104c, and a bit-processor 106c. The user equipment 100c may further comprise an HSDPA processing block 103c and a WCDMA processing block 105c. The HSDPA processing block 103c may comprise an HSDPA bit process block 112c, a virtual buffer 114c, and an HSDPA turbo decoding module (HTDM) 116c. The WCDMA processing block 105c may comprise a WCDMA bit process block 107c, a channel decoder 108c, and a cyclic redundancy check (CRC) checking block 110c.

The RF block 102c may comprise suitable logic, circuitry and/or code that may enable conversion of the electromagnetic wave transmitted by the network transmitter or base-station into an electric signal which is filtered and amplified through its receiver antenna and the frequency may be shifted to baseband. The signal may be sampled, converted to a numeric representation and output to the front-end block 104c. The front-end block 104c may comprise suitable logic, circuitry and/or code that may enable performance of numerous operations whereby the in-phase (I) and the quadrature (Q) chip values may be combined, where the chip frequency is 3.84 MHz, for example. Each of the 16 sequential values of I and Q may be projected on a set of orthogonal sequences, orthogonal variable spreading factor (OVSF) vectors, codes or functions and combined into a set of symbols, where a symbol may be represented by two numeric values, the in-phase component (I) and the quadrature component (Q).

The UE 100c may be allocated by the network k with k=1 . . . 15 OVSF functions. Due to the projection operation, at each chip-time, k symbols may be created. The rate of generating symbols may be chip-rate/16=3.84 MHz/16=240 kHz, for example. In HSDPA, the duration of receiving data may be partitioned into a transmission time interval (TTI) of 2 milliseconds, for example. The number of symbols per TTI may be k×960 symbols. The number k of OVSF functions allocated to the UE 100c may indicate that a network may be employed to control the rate of receiving data by the UE 100c. The number of OVSF functions represents a physical constraint of transmitting/receiving rate and may be referred to as a physical channel (Phy-Ch). For example, a mobile with k=1 indicates that one OVSF function or one Phy-Ch is being allocated to the UE 100c. The mobile may receive 960 symbols per TTI, for example, and this rate may be doubled by setting k=2, for example. In this case, the mobile simultaneously receives two streams of 960 symbols each, for example. The total symbol rate may directly indicate the data rate the UE 100c receives.

Each pair I,Q of a symbol may represent a pair of soft bits when QPSK modulation is used. Alternatively, the I,Q pair may pass through a slicing process whereby the two soft bits may be partitioned into 4 soft bits when QAM16 modulation is utilized. The numeric value or amplitude of a soft bit represents the certainty or probability that the bit is either one or zero. The multiple streams of soft bits may be input to the bit-processor block 106c.

The bit-processor block 106c may comprise suitable logic, circuitry and/or code that may be enabled to partition the received multiple streams of soft bits into two processes, the WCDMA bit process and the HSDPA bit process. The WCDMA processing may be performed by the WCDMA processing block 105c, and HSDPA processing may be performed by the HSDPA processing block 103c. One or more of the blocks within the WCDMA processing block 105c and the HSDPA processing block 103c may be implemented within the bit processor 106c.

The WCDMA bit process block 107c may process a portion of the multiple streams of received soft bits based on the WCDMA standard and includes a de-rate matching process that may be applied to the parity-1 bits and to parity-2 bits. The de-rate matching process may include reversing the rate matching process and mapping the received bits into their original addresses. The bitstream portion processed by the WCDMA bit process block 107c may be further processed by the channel decoder block 108c and the CRC checking block 110c.

The HSDPA process block 112c may process a portion of the multiple streams of received soft bits based on the HSDPA standard and may enable retransmission of an encoded block associated with a given TTI that failed to be decoded. The decoding of a data block may be carried out over several TTI's and the blocks of several processes may be stored in the virtual buffer 114c. An uplink to the base station may report the success by an acknowledgement (ACK) packet or the failure by a no acknowledgement (NACK) packet. The HSDPA process block 112c may be enabled to decode a block by facilitating the retransmit, or alternatively, initiating the transmit of a new block of data. A downlink channel known as HSDPA shared control channel (HSCCH), which is shared by all HSDPA users, may be received at each TTI. Its content identifies the UE 100c and it includes the necessary parameters that facilitate the decoding of the current data content of the current TTI. Data stored in the virtual buffer 114c may be decoded by the HTDM 116c.

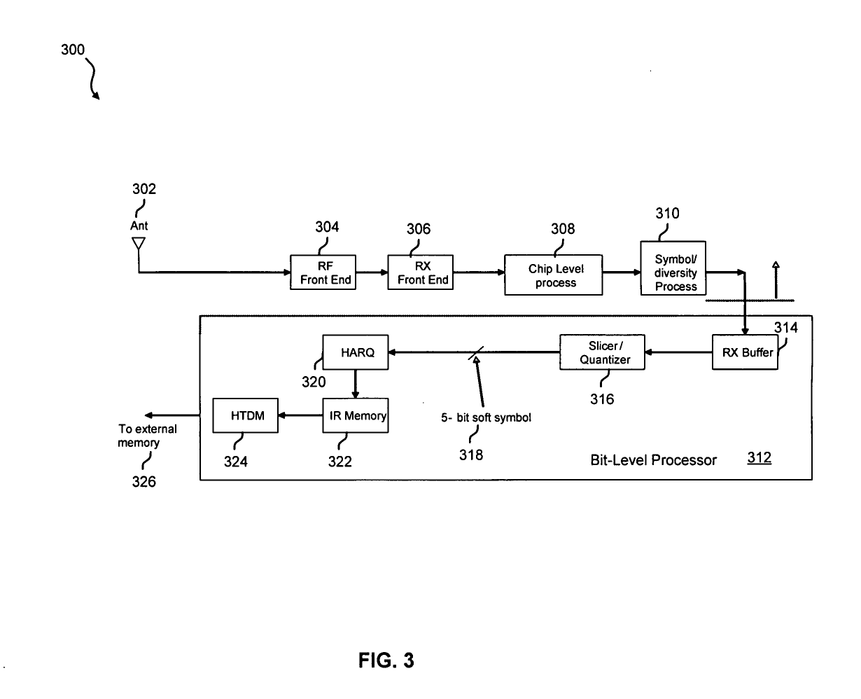

FIG. 3 is a high-level block diagram illustrating an exemplary data processing path for a received HSDPA signal, in accordance with an embodiment of the invention. Referring to FIG. 3, an HSDPA receiver circuit 300 may comprise an antenna 302, an RF front end block 304, a receiver (RX) front end block 306, a chip level processor 308, a symbol/diversity processor 310, and a bit level processor (BLP) 312. The BLP 312 may comprise a RX buffer 314, a slicer/quantizer block 316, a HARQ block 320, an IR memory 322, and an HSDPA turbo decoding module (HTDM) 324.

The RF front end block 304 may comprise suitable logic, circuitry and/or code that may enable conversion of the electromagnetic waves received via the antenna 302 from a network transmitter or a base-station into an electrical signal. The electrical signal may be further filtered and amplified and the frequency may be shifted to baseband. The signal may be sampled, converted to a numeric representation and output to the RX front end block 306. The RX front end block 306 may comprise suitable logic, circuitry, and/or code that may enable performance of numerous operations whereby the in-phase (I) and the quadrature (Q) chip values may be combined, where the chip frequency is 3.84 MHz, for example. Each of the 16 sequential values of I and Q may be projected on a set of orthogonal sequences, orthogonal variable spreading factor (OVSF) vectors, codes or functions and combined into a set of symbols. A symbol may be represented by two numeric values, the in-phase component (I) and the quadrature component (Q). Each I,Q pair of a symbol may represent a pair of soft bits when QPSK modulation is used. Alternatively, the I,Q pair may pass through a slicing process whereby the two soft bits may be partitioned into 4 soft bits when QAM16 modulation is utilized. The numeric value or amplitude of a soft bit represents the certainty or probability that the bit is either one or zero. The multiple streams of soft bits may be input to the chip level processor 308.

The chip level processor 308 may comprise suitable circuitry, logic, and/or code and may enable channel estimations of the actual time varying impulse response of the HSDPA channel per base station. Furthermore, the chip level processor 308 may be adapted to track in time and estimate a complex phase and/or amplitude values of the received signal. In this regard, channel estimates and timing information may be communicated to the symbol/diversity processing block 310. The symbol/diversity processing block 310 may comprise suitable logic, circuitry, and/or code that may be enabled to combine signals transmitted from multiple antennas in diversity modes, for example. The diversity modes may comprise open loop (OL), closed loop 1 (CL1), and closed loop 2 (CL2).

The BLP 312 may comprise suitable circuitry, logic, and/or code and may enable processing, such as decoding of received HSDPA bitstream based on the HSDPA standard and may enable retransmission of an encoded block associated with a given TTI that failed to be decoded. The decoding of an HSDPA data block may be carried out over several TTI's and the blocks of several processes may be stored in the virtual buffer, or IR memory 322. An uplink from the BLP 312 to a base station may report the success by an acknowledgement (ACK) packet or the failure by a no acknowledgement (NACK) packet.

The RX buffer 314 may comprise a circular buffer that may be enabled to store de-scrambled received data. The size of the RX buffer 314 may be larger than the maximum number of symbols per TTI period. For category 7 and 8, the maximum number of de-scrambled symbols per TTI may be 480*2 (I and Q)*10(codes)*10(bit-width for the de-scrambled symbols) which equals 96 kbits. The exact size of the RX buffer 314 may depend on how fast the HARQ module 320 processes a TTI-period of the data. The de-scrambled symbols received from the symbol/diversity processing block 310 may be stored in the RX buffer 314 in the order of the first I, Q symbols from channels 1-10 followed by the 2^{nd} I, Q symbols from channels 1-10, and so on. That is: I_{1,1}, Q_{1,1}, I_{1,2}, Q_{1,2}, I_{1,3}, Q_{1,3}, . . . I_{1,n}, Q_{1,n}, I_{2,1}, Q_{2,1}, I_{2,2}, Q_{2,2}, I_{2,3}, Q_{2,3}, . . . , I_{480,n}, Q_{480,n}, where “n” may be the index of the last physical channel. For 10 codes, n=10. Since the HARQ block 320 may function on a symbol-by-symbol basis, the size of the RX buffer 314 may be reduced to less than a TTI period, for example. The exact size of the RX buffer 314 may depend on the design of the HARQ block 320 and timing budget of the entire BLP 312. In one embodiment of the invention, the size of the RX buffer 314 may be 2 slots.

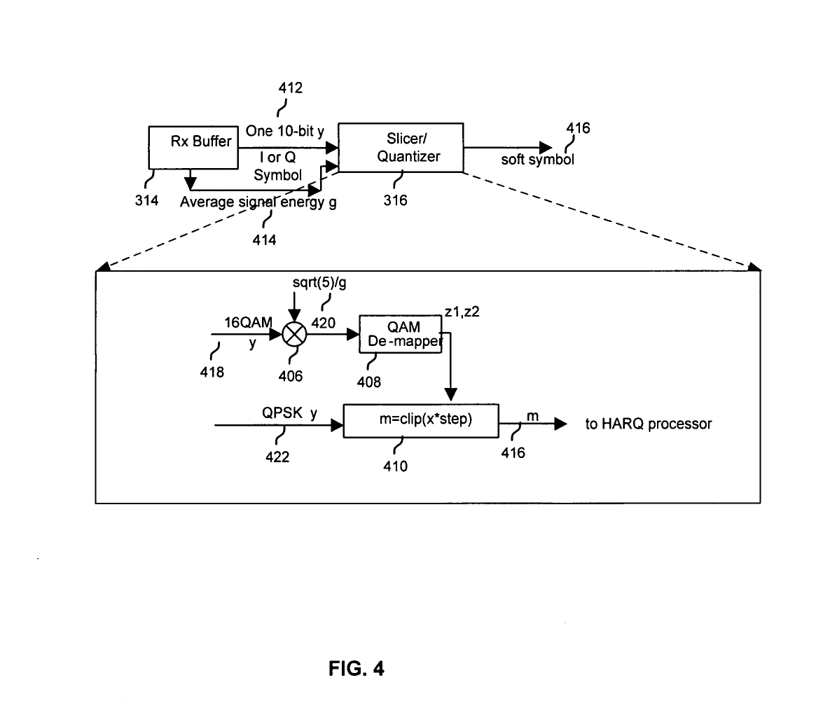

In operation, a signal from the symbol/diversity block 310 may trigger the RX buffer 314 to move data from internal memory of the symbol/diversity block 310 to the RX buffer 314. When data is moved from the symbol/diversity block 310 to the RX buffer 314, the signal energy over N symbols, for example, 64 symbols, for both I and Q may be calculated. This value may be used as the weight “g” in the slicer/quantizer 316 for the group of N received symbols, as described below with regard to FIG. 4. For each TTI, there may be seven groups of “64 symbols,” for example. The “g” value may be updated 7 times per TTI, and the last 32 symbols (480−7*64) may reuse the 7^{th} weight as their weight in the slicer/quantizer operation within the BLP 312. While the RX buffer 314 is writing data from diversity block to its memory space, the HSDPA receiver block 300 may activate the BLP 312 upon completing decoding of the HS-PDSCH data. The BLP 312 may then initiate reading 10-bit I, Q symbols from the RX buffer 314 and may pass them to the slicer/quantizer block 316 for further processing.

The slicer/quantizer block 316 may comprise suitable circuitry, logic, and/or code and may enable performing of the demodulation function for the 16 QAM signals, and/or quantization of the received signals to 5-bit soft symbols. The output of the slizer/quantizer block 316 may comprise a 5-bit soft symbol 318 and may be communicated to the HARQ processor 320 for further processing.

The HARQ processor 320 may comprise suitable circuitry, logic, and/or code and may enable performing of a plurality of processing functions, such as constellation re-arrangement for 16 QAM, 2^{nd} level de-interleaving on each physical channel, concatenation of the de-interleaved symbols from each physical channel, splitting the systematic, parity 1 and parity 2 symbol sequences, and/or de-rate-matching of the systematic, parity 1 and parity symbol sequences individually to de-match the symbols from their allocated physical channel capacity to the allocated IR memory capacity. In one embodiment of the invention, the BLP 312 may utilize a plurality of HARQ processors, each of which may be enabled to handle a particular portion of memory.

The IR memory 322 may comprise an on-chip memory. The size of the IR memory 322 may be 134400*5 (bit-width for the soft symbol)=672 kbits, for example. The IR memory 322 may be partitioned into a plurality of sectors, depending on the number of HARQ processors to be utilized within the BLP 312. In one exemplary embodiment of the invention, each HARQ processor may be allocated for one sector of IR memory by default. Furthermore, within each IR memory sector, the systematic symbols, parity 1 symbols and parity 2 symbols may be stored in three separate memory blocks.

The HSDPA turbo decoding module (HTDM) 324 may comprise suitable circuitry, logic, and/or code and may enable a plurality of processing function, such as 1^{st} rate de-matching, turbo decoding, de-scrambling, and/or cyclic redundancy check (CRC) checking. The HTDM 324 may receive data from the IR memory 322 and may perform rate matching 1 operations on the parity-1 and parity-2 bitstream. The resulting data may be decoded using turbo decoding with early termination based on CRC. The maximum iteration for the turbo decoding may be 8, for example. In case of multiple turbo coded blocks, maximum iterations may be performed on a plurality of coded blocks, except the last one. During the decoding of the last turbo block, the HTDM 324 may use the 1^{st} decoded block together with outputs from at least a portion of all previous decoded blocks, may de-scramble the concatenated bitstream, and may checks the CRC of the de-scrambled bits. U.S. application Ser. No. 11/141,478 (Attorney Docket No. BP 4630), filed on May 31, 2005, further describes a wireless terminal baseband processor high speed turbo decoding module and is hereby incorporated herein by reference in its entirety.

FIG. 4 is a block diagram of an exemplary slicer/quantizer block, in accordance with an embodiment of the invention. Referring to FIG. 4, the slicer/quantizer block 316 may comprise suitable circuitry, logic, and/or code and may enable demodulation function for the 16 QAM signals, and/or quantization of the received signals to 5-bit soft symbols. The output of the slizer/quantizer block 316 may comprise a 5-bit soft symbol 416 and may be communicated to the HARQ processor 320 for further processing. The slicer/quantizer block 316 may comprise a multiplier 406, a QAM de-mapper block 408, and a quantizer 410.

The slicer/quantizer block 316 may receive as inputs from the RX buffer 314 modulation type, number of physical channels, 10-bit I, Q symbols 412, and/or average signal energy “g” 414 of the N symbols in the RX buffer 314. For 16 QAM signals 418, the 10-bit I or Q symbol from the RX buffer 314 may be scaled by the average signal energy of the group of N input symbols in the TTI period using the multiplier 406 and a normalization factor (sqrt(5)/g) 420 to the 16 QAM constellation with {−3, −1, 1, 3} as reference points. The QAM de-mapping operation may be based on a decision region, where two output symbols I₀ and I₁ for input I or Q₀ or Q₁ for input Q symbols may be obtained. The output symbols may be forwarded to the quantizer 410, which may enable performing of fixed step quantization and generate the soft bits 416. A value soft_max may represent the maximum value corresponding to the bit-width of the soft symbols 416. For example, for 5-bit soft symbols 416 with one sign bit, soft_max=16. The quantizer 410 may utilize a clipping function, which may be expressed by the following equation:
clip(t)=max(min(t,soft_max−1),−(soft_max−1))

For a QPSK signal 422, the QAM-demapper function performed by the QAM de-mapper block 408 may be skipped. The quantization step for the QPSK signal 422 may be based on the average energy “g” of the N received symbols. For each pair of the 16 QAM (I, Q) symbol 418, the output of the slicer/quantizer 316 may be with interleaved I, Q order (I₀, Q₀, I₁, Q₁). For 16 QAM signal 418, the optimal quantization step size may be determined by the average energy of the output of the quantizer 410. In accordance with an embodiment of the invention, the quantization step of the quantizer 410 may vary. For example, a fixed quantization step size, such as 5-bit soft symbol 416 for 16 QAM slicer/quantizer 316 may be used. The average signal energy “g” 414 over every N input symbols may be used during slicing and quantization.

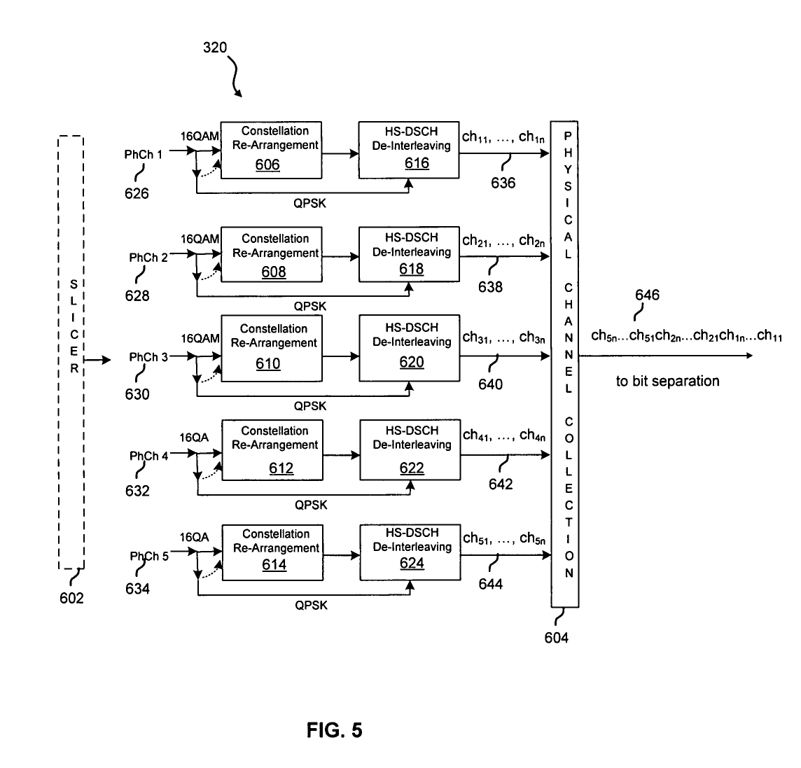

FIG. 5 is a block diagram of an exemplary hybrid automatic request (HARQ) processor, in accordance with an embodiment of the invention. Referring to FIG. 5, the HARQ processor 320 may comprise a plurality of constellation re-arrangement blocks (CRB) 606, . . . , 614, a plurality of HS-DSCH de-interleaving blocks (HDB) 616, . . . , 624, and a physical channel collection block (PCCB) 604.

The CRB 606, . . . , 614 may comprise suitable circuitry, logic, and/or code and may be enabled to perform constellation re-arrangement for the soft bit symbols received from the slicer 602. The soft bit symbols may be communicated from the slicer 602 to the CRB 606, . . . , 614 via physical channels 626, . . . , 634, respectively. For 16-QAM symbols, CRB 606, . . . , 614 may perform constellation re-arrangement for the output from the slicer/quantizer 602 (I₀, Q₀, I₁, Q₁). The constellation re-arrangement may be based on the constellation version parameter “b” derived from redundancy version RV information in the HS-SCCH. Table 2 illustrates the output as function of “b” after the constellation re-arrangement operation on the qua-triple input (I₀, Q₀, I₁, Q₁).

TABLE 2
Constellation Re-arrangement for 16-QAM

| constellation | | |
|---|---|---|
| version | Output | |
| parameter b | sequence | Operation |
| 0 | I₀, Q₀, I₁, Q₁ | None |
| 1 | I₁, Q₁, I₀, Q₀ | Swapping MSBs with LSBs |
| 2 | I₀, Q₀, −I₁, −Q₁ | Inversion of the logical values |
| | | of LSBs |
| 3 | I₁, Q₁, −I₀, −Q₀ | Swapping MSBs with LSBs and |
| | | inversion of logical values of |
| | | LSBs |

Table 3 below illustrates the coding of the RV in turns of the constellation re-arrangement parameter “b”, the systematic bit prioritize transmission parameter “s” (s=1, prioritize the systematic bits during 2^{nd} stage rate matching), and the parameter “r” that determines the initial error variable eᵢₙᵢ of the 2^{nd} stage rate matching.

TABLE 3
Redundancy Version Coding for 16-QAM

| RV(value) | s | r | b |
|---|---|---|---|
| 0 | 1 | 0 | 0 |
| 1 | 0 | 0 | 0 |
| 2 | 1 | 1 | 1 |
| 3 | 0 | 1 | 1 |
| 4 | 1 | 0 | 1 |
| 5 | 1 | 0 | 2 |
| 6 | 1 | 0 | 3 |
| 7 | 1 | 1 | 0 |

The HDB 616, . . . , 624 may comprise suitable circuitry, logic, and/or code and may enable HS-DSCH de-interleaving of the output received from CRB 606, . . . , 614, respectively. The HS-DSCH de-interleaving may be performed for each physical channel 626, . . . , 634 separately. The de-interleavers 616, . . . , 624 may comprise fixed-size block de-interleavers with 32 rows and 30 columns, for example. The fixed-size block de-interleaver may be the same as the 2^{nd} de-interleaver for the normal WCDMA channels. In this regard, the inputs to the HDB 616, . . . , 624 may be written to the de-interleavers on a column-by-column basis, and may be followed by an inter-column permutation based on the pattern described in Table 4. The data may then be read out from the permuted matrix on a row-by-row basis.

TABLE 4
Inter-Column Pattern Permutation

| Number of | Inter-column permutation pattern |
|---|---|
| columns C2 | <P2(0), P2(1), . . . , P2(C2-1)> |
| 30 | <0, 20, 10, 5, 15, 25, 3, 13, 23, 8, 18, 28, 1, 11, 21, |
| | 6, 16, 26, 4, 14, 24, 19, 9, 29, 12, 2, 7, 22, 27, 17> |

For a 16-QAM signal, there may be 1920 soft symbols per physical channel. In one embodiment of the invention, two basic de-interleavers may be used for processing a 16-QAM signal. The input soft symbols 318 may be divided two-by-two between the de-interleavers. Assuming for each physical channel 626, . . . , 634 that output from the constellation re-arrangement of CRB 606, . . . , 614 may be as follows:

Î₀, \hat{Q}₀, Î₁, \hat{Q}₁, Î₂, \hat{Q}₂, Î₃, \hat{Q}₃, . . . , Î₄₇₈, \hat{Q}₄₇₈, Î₄₇₉\hat{Q}₄₇₉.

In this regard, the symbols

Î₀, \hat{Q}₀, Î₂, \hat{Q}₂, . . . , Î₄₇₆, \hat{Q}₄₇₆, Î₄₇₈, \hat{Q}₄₇₈,

may be communicated to the first de-interleaver and the following symbols:

Î₁, \hat{Q}₁, Î₃\hat{Q}₃, . . . , Î₄₇₇, \hat{Q}₄₇₇Î₄₇₉, \hat{Q}₄₇₉,

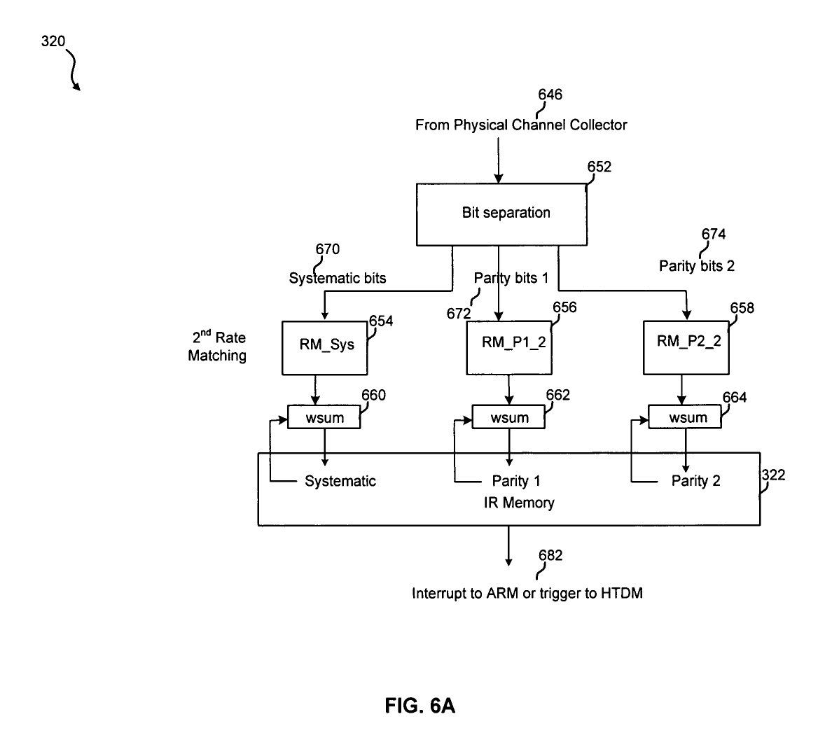

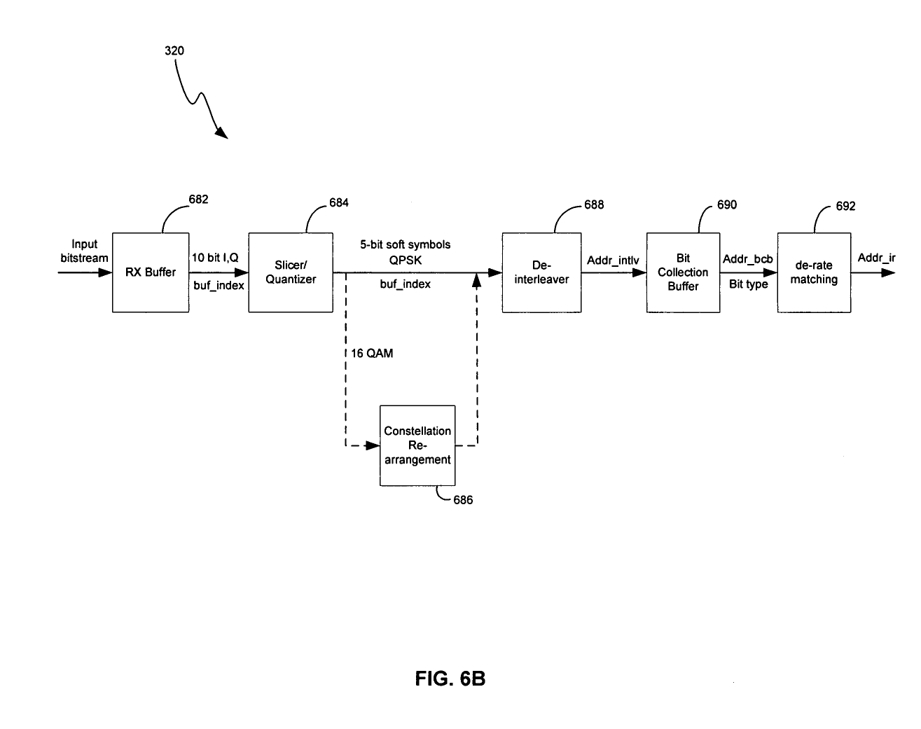

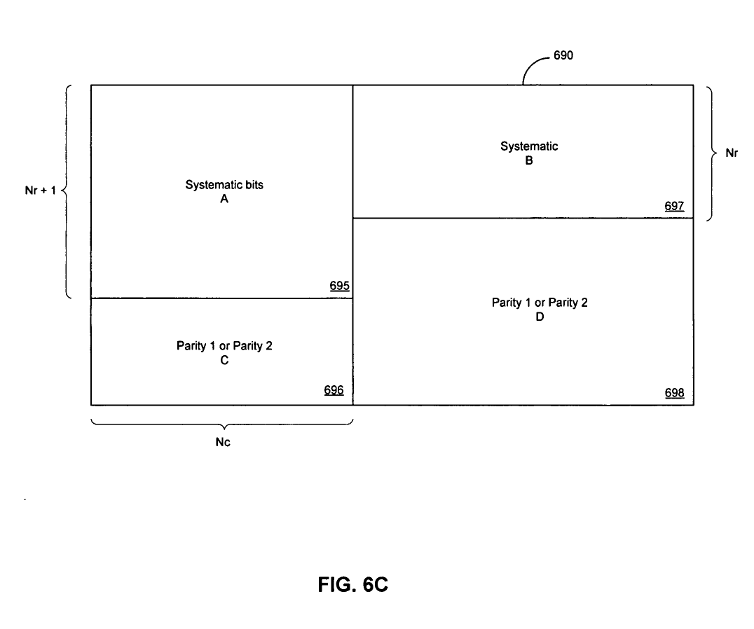

may be communicated to the second interleaver. Symbols may then be re-collected two-by-two from the de-interleavers. Assuming symbols v₀, v₁, v₂, . . . v₉₅₉ are obtained from the first de-interleaver and w₀, w₁, w₂, . . . , w₉₅₉ are obtained from the 2^{nd} de-interleaver, then the collected-output symbols of the de-interleaver for 16 QAM may be represented as v₀, v₁, w₀, w₁, v₂, v₃, w₂, w₃, . . . , v₉₅₈, v₉₅₉, w₉₅₈, w₉₅₉. The output symbols 636, . . . , 644 from the de-interleaver 616, . . . , 624 for each physical channel 626, . . . , 634 may be concatenated together by the PCCB 604 to form input symbols 646 to the bit-separation block 652 illustrated in FIG. 6B.

FIG. 6A is a block diagram of an exemplary HARQ processor, in accordance with an embodiment of the invention. Referring to FIG. 6A, the HARQ processor 320 may also comprise a bit separation block 652, 2^{nd} rate matching blocks (SRMB) 654, . . . , 658, and IR/Chase combining blocks (ICCB) 660, . . . , 664.

In accordance with an embodiment of the invention, the following parameters may be configured by a host processor as inputs to the HARQ hardware module 320: modulation type, number of physical channels, constellation re-arrangement parameter “b”, intermediate values Nᵣ and N_{c} related to the systematic bits for the bit separation operation, and/or parameters for 2^{nd} rate matching for systematic, parity 1 and parity 2 symbols and the corresponding rate matching modes, such as No RM, repetition, or puncturing. In addition, the HARQ hardware module 320 may receive as inputs individual IR addresses for systematic, parity 1 and parity 2 symbols, the weights for the IR data, and the weight for the current received data. The IR address may indicate to the HARQ processor 320 to fetch the data from a given address, weighted-sum the fetched data and the current received data. The HARQ processor 320 may store an output in the corresponding IR memory address indicated in the input parameters list.

The bit separation block 652 may comprise suitable circuitry, logic, and/or code and may be enabled to perform bit separation on the output signal 646 from the PCCB 604. Bit separation may be achieved using rectangular de-interleaver of size N_{row}×N_{col}, for example. The number of rows and columns may be determined from the following equations:
N_{row}=4 for 16 QAM and N_{row}=2 for QPSK
N_{col}=N_{data}/N_{grow}

$$where {N}_{data} = \{ \begin{matrix}960 * {N}_{phy} & QPSK \\ 1920 * {N}_{phy} & 16 - QAM ,\end{matrix}$$

N_{phy} is the number of physical channels.

Accordingly, N_{col}=480*N_{phy}. Data may be written into the de-interleaver column-by-column. N_{t,sys} may indicate the number of systematic symbols 670. Intermediate values Nᵣ and N_{c} may be calculated using the following equation:

$${N}_{r} = ⌊ \frac{{N}_{t , sys}}{{N}_{col}} ⌋ and {N}_{c} = {N}_{t , sys} - {N}_{r} \cdot {N}_{col} .$$

If Nc=0 and Nr>0, the systematic symbols 670 may be read out from rows 1 . . . Nr. Otherwise systematic symbols may be read out from rows 1 . . . Nr+1 in the first Nc columns and, if Nr>0, also read out from rows 1 . . . Nr in the remaining Ncol-Nc columns. The parity symbols 672 and 674 may be read out from the remaining rows of the respective columns. Parity 1 symbols 672 and parity 2 symbols 674 may be read out in alternating order, starting with parity 2 symbols 674 in the first available column with the lowest index number. In the case of 16 QAM for each column the symbols are read out of the de-interleaver in the order row 1, row 2, row 3, row 4. In the case of QPSK signals, for each column the symbols may be read out of the de-interleaver in the order row1, row2.

The SRMB 654, . . . , 658 may comprise suitable circuitry, logic, and/or code and may be enabled to perform de-rate-matching on systematic bits 670, parity 1 bits 672, and parity 2 bits 674. The separated systematic symbols 670, parity 1 symbols 672, and parity 2 symbols 674 may be de-rate-matched individually by the SRMB 654, 656, and 658, respectively. The 2^{nd} rate matching operation may remove inserted symbols if the total physical channel band-width N_{data}≧N_{IR}, indicating repetition, where N_{IR} may indicate the allocated total IR memory for the given HARQ processor 320. The SRMB 654, . . . , 658 may insert erasures “0,” if N_{data}<N_{IR}, which indicates puncturing. The priority indication bit “s” coded in the redundancy version carried by the HS-SCCH may determine whether the 2^{nd} rate matching prioritizes the systematic bits, if s=1, or non-systematic bits, if s=0, when puncturing is needed in the transmission. If the priority is for systematic bits, then the systematic bits may have the least number of punctured bits. The rate matching parameters for 2^{nd} rate matching may be pre-calculated using Layer 1 ARM codes, for example, for redundancy versions. The pre-calculation may be performed when the transport block size is known to the host processor, such as an ARM processor, via higher layer signaling.

The ICCB 660, . . . , 664 may comprise suitable circuitry, logic, and/or code and may enable combining of the outputs of the SRMB 654, . . . , 658 with corresponding systematic or parity symbols stored in the IR memory 322 to form a combined result. Various combining schemes may be utilized and may comprise Chase combining weighted by signal-to-interference ratio (SIR), equal-gain IR combining, weighted IR combining, and/or combining using threshold to replace the existing data in the IR memory, to discard the current received data, or to weighted-combine. The combined result may be clipped to 5-bit soft-symbol, for example, and the clipping result may be stored in the corresponding IR memory location from which the IR data is retrieved. The IR memory 322 may then generate an interrupt/trigger signal 682. An interrupt may be communicated to the host processor, and a trigger signal may be communicated to the HTDM 324.

In one embodiment of the invention, HARQ processing within the BLP 312 may be implemented without the use of a buffer by utilizing pointer calculation, for example, based on a function in the HARQ processor 320. The input to the HARQ processor 320 may be the index of the Rx buffer 314 and the received signal residing in the Rx buffer 314. The output of the HARQ pointer calculation may be the index of the IR memory 322 corresponding to the input index. In this regard, the BLP 312 may utilize the Rx buffer 314 and IR memory 322 for buffering, resulting in reduced memory use by the BLP 312. Furthermore, through several memory address calculations operation between the Rx buffer 314 and IR memory 322, Rx buffer size may be reduced to less than 2 time slots, for example.

FIG. 6B is an exemplary block diagram illustrating the implementation of a bufferless hybrid automatic request (HARQ) processor, in accordance with an embodiment of the invention. Referring to FIG. 6B, there is shown a HARQ processor 320. The HARQ processor 320 may comprise a Rx buffer 682, a slicer/quantizer block 684, a constellation re-arrangement block 686, a de-interleaver 688, a bit collection buffer 690, and a second de-rate matching block 692. These blocks may be substantially as described in FIG. 3, FIG. 6A and FIG. 6B.

In one embodiment of the invention, a buffer-less implementation of the HARQ process may be implemented via pointer calculation based on a given function in the HARQ processor 320. The input to the HARQ processor 320 may be the index of an Rx buffer 682 and the received signal residing in an Rx buffer 682. The output of the HARQ pointer calculation may be the index of the IR memory 322 corresponding to the input index. If the received data is re-transmitted, then the module may retrieve data residing in this calculated IR memory index, combines the quantized-received data with the retrieved data, and places the combined 5-bit result in the corresponding IR memory 322. A large amount of buffers required to store intermediate results for the HARQ processor 320 are no longer needed. Furthermore, through several memory address calculation operations between Rx buffer 682 and IR buffer 322, Rx buffer size may be reduced to less than 2 time slots instead of the 3 time slots, for example. U.S. application Ser. No. ______ (Attorney Docket No. 16879US01) filed on even date herewith discloses a detailed description of a method and system for randomized puncturing in mobile communication systems and is hereby incorporated by reference in its entirety.

The HARQ processor 320 may comprise two internal counters, for example. One of the counters may track the index of the Rx buffer 682 buf_index that the HARQ 320 is currently processing. The other counter may track the symbol index idx_sym within a TTI for each physical channel. When the HARQ operation is activated by the bit level processor 312, the values of the two counters may be set to 0. If there are Nph physical channels, then buf_index=idx_sym*Nph+idx, 0≦idx<Nph, where idx is the channel index. The bit level processor 312 may process a group of Nph symbols at a time. For a given pair of (idx_sym, idx), the memory address output of the slicer/quantizer 684 for QPSK type modulation may be determined according to the following equation:
idx_quan=2*(buf_index)+j, j=0 for I symbol, j=1 for Q symbol

In an exemplary embodiment of the invention, the output symbol values may be 5-bit quantized results and may be denoted as quan_i, quan_q. The four triplets (addr1, addr2, I/Q, v_addr)=(idx_sym, idx, 0, quan_i) may be the corresponding value for I symbol, and (addr1, addr2, I/Q, v_addr)=(idx_sym, idx, 1, quan_q) may be the corresponding value for Q symbol. For 16-QAM and for a given Rx buffer index, there may be four triplets. Each I/Q symbol may be sliced into two I-symbols or two Q-symbols as:
(idx_sym,idx,0,quan_i0,quan_i1)
(idx_sym,idx,1,quan_q0,qun_q1)

After constellation re-arrangement 686, the output may be listed according to Table 1:

TABLE 1

| Constellation index | (addr1,addr2,I/Q,quan_out0,quan_out1) |
|---|---|
| 0 | (idx_sym,idx,0,quan_out0,quan_out1) |
| 1 | (idx_sym,idx,0,quan_out1,quan_out0) |
| 2 | (idx_sym,idx,0,quan_out0,−quan_out1) |
| 3 | (idx_sym,idx,0,−quan_out1,quan_out0) |

The de-interleaver 688 may be enabled to calculate the index of the de-interleaver output and offset by 960*idx for QPSK or 1920*idx for 16 QAM. The de-interleaver 688 may be enabled to calculate the output intlv_out with input index intlv_in and an array based on the following equations:
row=intlv_in %32
col=intlv_in/32
col=secondPerm[col]
intlv_out=(row*30+col)
where secondPerm[col] is an array.

Table 2 illustrates the input/output address mapping and the corresponding signal value for de-interleaving or the physical channel collection module when the modulation type is QPSK, in accordance with an embodiment of the invention.

TABLE 2
QPSK

| Input address | | | |
|---|---|---|---|
| triplet | Intlv_in | Addr_Intlv | Signal_value |
| (idx_sym,idx,0) | 2*Idx_sym | Intlv_out0+960*idx | Quan_i |
| (idx_sym,idx,1) | 2*idx_sym+1 | Intlv_out1+960*idx | Quan_q |

Table 3 illustrates the input/output address mapping and the corresponding signal value for de-interleaving or the physical channel collection module when the modulation type is 16 QAM, in accordance with an embodiment of the invention.

TABLE 3
16-QAM

| Input address | | | | |
|---|---|---|---|---|
| triplet | Intlv_in | Intlv_out | Addr_Intlv | Signal_value |
| (idx_sym,idx,0) | 2*Idx_sym | even | 2*Intlv_out+1920*idx | Quan_i0 |
| | | odd | 2*Intlv_out+1920*idx+1 | Quan_i1 |
| (idx_sym,idx,1) | 2*idx_sym+1 | even | 2*Intlv_out+1920*idx | Quan_q0 |
| | | odd | 2*Intlv_out+1920*idx+1 | Quan_q1 |

The de-rate matching block 692 may be enabled to calculate a plurality of de-rate matching parameters, for example, Xi, e_plus, e_minus, e_ini from the Gamma and Offset values, according to the following exemplary rules:
If no rate matching:
   Gamma=1, Offset=0
If repetition:
   Gamma=e_plus+e_minus
   Offset=e_ini
If puncturing:
   Gamma=e_plus−e_minus
   Offset=e_plus−e_ini

The de-rate matching parameters, for example, Xi, e_plus, e_minus, e_ini may be fixed per TTI and are passed to the hardware module via an interface control register. In an exemplary embodiment of the invention, a rate matching mode may be passed to the hardware using one bit to pass this information. For repetition, the bit may be set to 0, but for puncturing and no rate matching, the bit may be set to 1. The output address Drm2_out of the de-rate matching block 692 for a given bit-type based on the Gamma and Offset value may be determined according to the following exemplary algorithm:

If (rate matching mode is puncturing)

Drm2_out =(Bco_out *e_plus+Offset)/Gamma;

If (rate matching mode is repetition)
{

Drm2_out = (Bco_out *e_plus+Offset)/Gamma;
If ((Bco_out *e_plus+Offset)%Gama==0)

Drm2_out = Drm2_out −1;

}

For each bit type, firmware may allocate starting address of the IR memory 322 for that bit-stream, for example, IR_sys, IR_p1, and IR_p2. The final IR memory address, IRmem_adr, of the input signal from the Rx buffer 682 may be determined according to the following equation:
IRmem_adr=Drm2_out+IR_sys, or
IRmem_adr=Drm2_out+IR_{—}p1, or
IRmem_adr=Drm2_out+IR_{—}p2.
This address may be used to retrieve data from IR memory 322 if required for IR combining and to store the final combined data or the initial transmitted data.

FIG. 6C is an exemplary block diagram of a bit collection buffer, in accordance with an embodiment of the invention. The bit collection buffer 690 may receive the address Addr_Intlv derived from Table 2 and Table 3 and calculate the bit type, for example, systematic, parity 1 or parity 2, and its corresponding index within its bit-stream. The bit-type may be determined by the four regions 695, 696, 697, and 698 where Nr and Nc may be calculated by the firmware. For a given index Addr_Intlv, the region where the symbol is located may be determined by the corresponding column and row. For QPSK, the column and row are determined according to the following equations:
Col=Addr_Intlv>>1
Row=Addr_Intlv % 2
For 16-QAM, the column and row are determined according to the following equations:
ColAddr_Intlv>>2
Row=Addr_Intlv % 4

The bit-type may be determined using, for example, a table-lookup in order to expedite the bit-type determination process. In an exemplary embodiment of the invention, an 8×4 table may be utilized for QAM, and a 4×2 table may be utilized for QPSK. After the bit-type is determined, the output address of the bit collection buffer 690, Bco_out, may be calculated according to the following exemplary algorithm:

if (col < Nc)
{

A = col*(Nr+1);
if (bit_type is systematic bit)

Bco_out =A+row;

else

Bco_out =( Addr_Intlv − (A+Nr+1))>>1;

}
else
{

A = Nr*col+Nc;
if (bit_type is systematic bit)

Bco_out = A+row;

else

Bco_out = ( Addr_Intlv − (A+Nr))>>1;

}

The calculated output address of the bit collection buffer 690 Bco_out may be received by the de-rate matching block 692 to determine the final memory address.

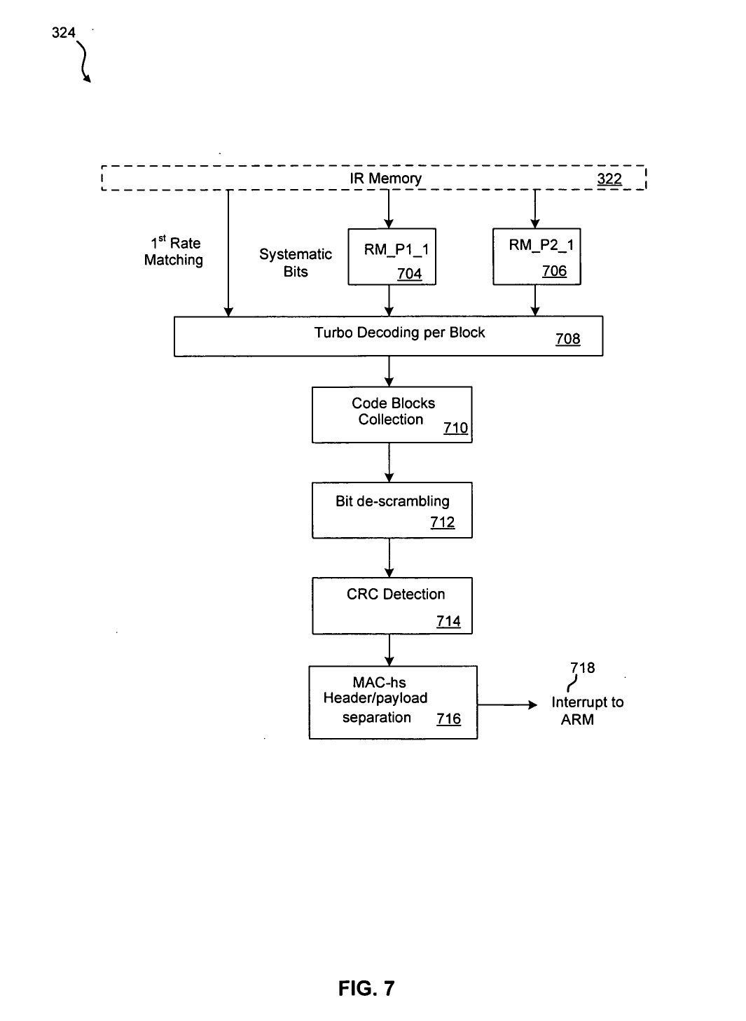

FIG. 7 is a block diagram of an exemplary HSDPA turbo decoding module (HTDM), in accordance with an embodiment of the invention. Referring to FIG. 7, the HTDM 324 may comprise first rate matching blocks (FRMB) 704 and 706, a turbo decoding block 708, code blocks collection module (CBCM) 710, a bit de-scrambling block 712, CRC detection block 714, and a header/payload separation block (HPSB) 716.

In one embodiment of the invention, a host processor may configure the following parameters as input to the HTDM 324: turbo decoder related parameters, such as interleaver prime number and/or number of columns; number of coded turbo blocks, the size of the pre-coded block, and number of pre-code fill bits; and parameters for 1st rate matching for parity 1 and parity 2 symbols and the corresponding rate matching modes, such as No RM or puncturing. The host processor may also configure the following parameters as input to the HTDM 324: individual IR addresses for systematic, parity 1 and parity 2 symbols; table for the mapping between SID (size index identifier) for each queue ID (QID) and the MAC-d PDU size; and decoding output mode. The decoding output modes may comprise outputting decoded bits as one whole block and splitting the MAC header and data as two separate blocks aligned in the word boundary. The decoding output modes may also comprise decoding MAC header and output each filed MAC header and each MAC-PDU in separate blocks word-aligned, and decoding MAC header and output each filed MAC header and splits the CTX filed and MAC-PDU in separate word boundary.

The FRMB 704 and 706 may comprise suitable circuitry, logic, and/or code and may enable first rate matching on parity 1 and parity 2 bits, respectively, received from the IR memory 322. The 1^{st} rate matching operation may be the same as the rate matching operation for the normal WCDMA data block, except that only puncturing may be performed. In this regard, if the number of coded data bits is smaller than the allocated IR memory 322, then no operation may be performed on the block.

The turbo decoding block 708 may comprise suitable circuitry, logic, and/or code and may be enabled to perform 1/3 rate turbo decoding with iterations. Furthermore, to reduce decoding complexity, early termination based on CRC may be used. After iterative decoding of the first decoder, decoded systematic bits, parity 1 and parity 2 bits may be combined by the code block collection module 710. The bits may then be de-scrambled by the bit de-scrambling block 712. The CRC detection block 714 may perform CRC checking on the de-scrambled decoded bits received from the bit de-scrambling block 712. The bit scramble function may use the turbo decoded bits and scramble it with the bit sequence defined by the HSDPA specification.

If the CRC passes, then the decoding may be terminated. Otherwise, the HTDM 324 may continue with the next round of the decoding until it reaches the maximum iteration. For multiple turbo coded blocks, early termination may be performed on the last of the coded blocks. For example, a maximum of 3 turbo coded blocks may be possible for Category 7 or 8. During decoding, the first two coded blocks may go through 8 iterative decoding. The decoded bits may be stored in the internal memory of the HTDM 324. During the decoding of the last coded block, at the end of every decoding from the 1^{st} decoder, the decoded bits together with the decoded bits from the previous two blocks may be concatenated, de-scrambled and CRC checked. If CRC passes, then the decoding may be terminated. After CRC checking passes, the decoded bitstream may be communicated to the HPSB 716. The HPSB 716 may decode the header of the MAC-hs PDU and, based on the header information, the HPSB 716 may format the output into a corresponding format. The HTDM 324 may output data in four different formats configured by the ARM. Three of the formats may split the MAC header from the payload of the decoded bits to save processor instruction cycles, utilizing the HPSB 716. The split payload and header of the decoded bits may then be transferred to external memory.

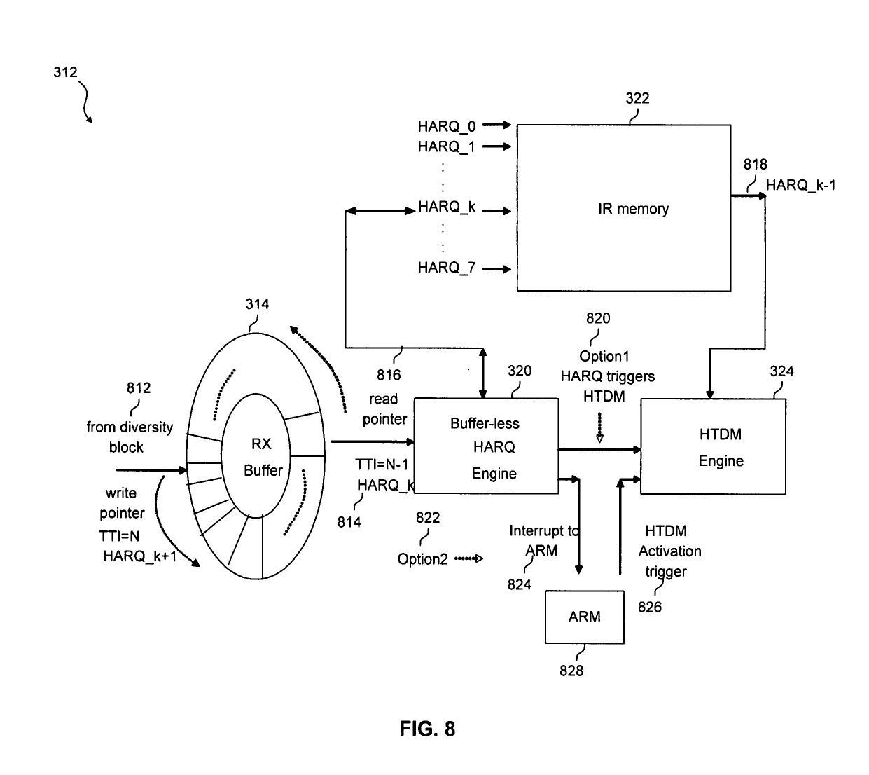

FIG. 8 is a block diagram of bit level processor (BLP) architecture, in accordance with an embodiment of the invention. Referring to FIG. 8, the BLP 312 may comprise an RX buffer 314, an IR memory 322, a HARQ processor 320, an HTDM engine 324, and a host processor, such as an ARM processor 828. The functionalities of RX buffer 314, the IR memory 322, the HARQ processor 320, and the HTDM engine 324 are explained herein with respect to FIG. 3 above.

In accordance with an embodiment of the invention, the BLP 312 may be configured to operate in a pipeline fashion to achieve higher throughput. For example, while the RX buffer 314 is moving the received soft symbols from the diversity block for the current TTI block 812, the HARQ processor 320 may be operating on the previous TTI block 814, and the HTDM 324 may be processing (current-2) block 818. In this regard, one engine does not have to wait for the completion of other processors. Therefore, minimum packet decoding delay and higher data throughput may be achieved. In addition, flexible interface control may be provided between the HARQ processor 320 and the HTDM 324. The two engines may be configured and operated separately via their corresponding set of interface control registers.

Operation of the HTDM 324 may be triggered via two options—option 1 820 and option 2 822. Under option 1 820, upon completing processing of a block, the HARQ engine 320 may communicate a signal directly to the HTDM 324. When option 1 820 is used, the two sets of the control interface registers may be configured by firmware prior the initiation of the HARQ engine 320. Under option 2 822, when HARQ 320 completes processing of a block, it may communicate an interrupt 824 to the ARM 828. When the ARM 828 receives the interrupt 824, the ARM 828 may communicate an HTDM activation trigger signal 826, which may configure the HDTM control interface registers and may actives the HDTM 324.

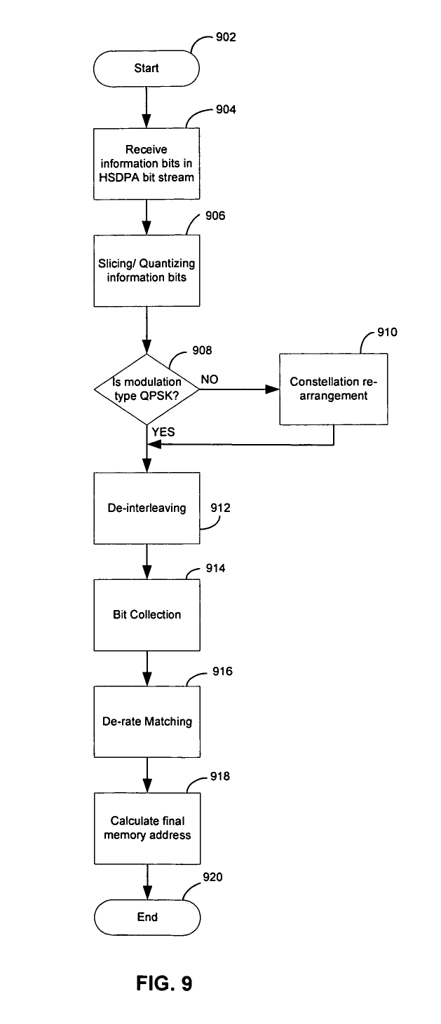

FIG. 9 is a flowchart illustrating implementation of a bufferless HARQ processor, in accordance with an embodiment of the invention. Referring to FIG. 9, exemplary steps may start at step 902. In step 904, the Rx buffer 314 may receive a plurality of information bits in a HSDPA bitstream. In step 906, the slicer/quantizer 684 enables slicing of a portion of the plurality of information bits in the received HSDPA bitstream to determine the quantized value of the soft bits and the corresponding addresses. In step 908, it may be determined whether the modulation type of the portion of the plurality of information bits is QPSK. If the modulation type of the portion of the plurality of information bits is QPSK, control passes to step 912. If the modulation type of the portion of the plurality of information bits is QAM and not QPSK, control passes to step 910. In step 910, the constellation rearrangement block 686 may enable generation of the soft bit values for a plurality of physical segments for QAM. Control then passes to step 912.

In step 912, the de-interleaver 688 may be enabled to calculate the index of the de-interleaver output and offset by 960*idx for QPSK or 1920*idx for 16 QAM. In step 914, the bit collection buffer 690 may receive the address Addr_Intlv from the de-interleaver 688 and calculate the bit type, for example, systematic, parity 1 or parity 2, and its corresponding index within its bit-stream. In step 916, the de-rate matching block 692 enables streaming of the portion of the plurality of information bits in the received HSDPA bitstream into at least one of: systematic de-rate matching, parity-1 de-rate matching, and parity-2 de-rate matching based on a bit type associated with the portion of the plurality of information bits in the received HSDPA bitstream. In step 918, the final memory addresses may be calculated. Control then passes to end step 920.

In an embodiment of the invention, a method and system for processing signals in a communication system may comprise circuitry that enables mapping at least a portion of a plurality of information bits in a received HSDPA bitstream to particular memory addresses without buffering the plurality of information bits during hybrid automatic request (HARQ) processing. The circuitry, for example, slicer/quantizer 684 may enable quantization of the portion of the plurality of information bits in the received HSDPA bitstream. The circuitry, for example, bit level processor 312 enables partitioning processing of the plurality of information bits in the received HSDPA bitstream into a functional data processing path and a functional address processing path. The calculation of the memory addresses for the portion of the plurality of information bits comprises at least one of: de-interleaving, bit collection, and de-rate-matching.

The circuitry, for example, the constellation re-arrangement block 684 enables constellation re-arrangement prior to the de-interleaving, if modulation type of the portion of the plurality of information bits is quadrature amplitude modulation (QAM). The circuitry, for example, the de-rate matching block 692 enables streaming during de-rate matching, the portion of the plurality of information bits in the received HSDPA bitstream into at least one of: systematic de-rate matching, parity-1 de-rate matching, and parity-2 de-rate matching based on a bit type associated with the portion of the plurality of information bits in the received HSDPA bitstream. The circuitry, for example, the de-rate matching block 692 enables address calculation during de-rate matching, at least one de-rate matching parameter to calculate the memory address of the portion of the plurality of information bits. The circuitry, for example, bit level processor 312 enables erasing of previously stored data in the IR memory 322 in response to receiving a new portion of the received plurality of information bits. The circuitry, for example, bit level processor 312 enables combining of previously stored data in the IR memory 322 with the portion of the received plurality of information bits.

One embodiment of the present invention may be implemented as a board level product, as a single chip, application specific integrated circuit (ASIC), or with varying levels integrated on a single chip with other portions of the system as separate components. The degree of integration of the system will primarily be determined by speed and cost considerations. Because of the sophisticated nature of modern processors, it is possible to utilize a commercially available processor, which may be implemented external to an ASIC implementation of the present system. Alternatively, if the processor is available as an ASIC core or logic block, then the commercially available processor may be implemented as part of an ASIC device with various functions implemented as firmware.

The present invention may also be embedded in a computer program product, which comprises all the features enabling the implementation of the methods described herein, and which when loaded in a computer system is able to carry out these methods. Computer program in the present context may mean, for example, any expression, in any language, code or notation, of a set of instructions intended to cause a system having an information processing capability to perform a particular function either directly or after either or both of the following: a) conversion to another language, code or notation; b) reproduction in a different material form. However, other meanings of computer program within the understanding of those skilled in the art are also contemplated by the present invention.

While the invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

What is claimed is:

1. A method for processing signals in a communication system, the method comprising mapping at least a portion of a plurality of information bits in a received HSDPA bitstream to particular memory addresses without buffering said at least portion of said plurality of information bits during hybrid automatic request (HARQ) processing.

2. The method according to claim 1, further comprising slicing said portion of said plurality of information bits in said received HSDPA bitstream to determine said memory addresses.

3. The method according to claim 1, further comprising quantizing said portion of said plurality of information bits in said received HSDPA bitstream to determine said memory addresses.

4. The method according to claim 1, further comprising partitioning processing of said plurality of information bits in said received HSDPA bitstream into a functional data processing path and a functional address processing path.

5. The method according to claim 1, wherein said calculation of said memory addresses for said portion of said plurality of information bits comprises at least one of: de-interleaving, bit collection, and de-rate-matching.

6. The method according to claim 5, further comprising, if modulation type of said portion of said plurality of information bits is quadrature amplitude modulation (QAM), constellation re-arranging is performed prior to said de-interleaving.

7. The method according to claim 5, further comprising streaming during said de-rate matching, said portion of said plurality of information bits in said received HSDPA bitstream into at least one of: systematic de-rate matching, parity-1 de-rate matching, and parity-2 de-rate matching based on a bit type associated with said portion of said plurality of information bits in said received HSDPA bitstream.

8. The method according to claim 5, further comprising calculating during said de-rate matching, at least one de-rate matching parameter to calculate said memory address of said portion of said plurality of information bits.

9. The method according to claim 1, further comprising erasing previously stored data in said IR memory in response to receiving a new portion of said received plurality of information bits.

10. The method according to claim 1, further comprising combining previously stored data in said IR memory with said portion of said received plurality of information bits.

11. A machine-readable storage having stored thereon, a computer program having at least one code section for processing signals in a communication system, the at least one code section being executable by a machine for causing the machine to perform steps comprising mapping at least a portion of a plurality of information bits in a received HSDPA bitstream to particular memory addresses without buffering said at least portion of said plurality of information bits during hybrid automatic request (HARQ) processing.

12. The machine-readable storage according to claim 11, further comprising code for slicing said portion of said plurality of information bits in said received HSDPA bitstream to determine said memory addresses.

13. The machine-readable storage according to claim 11, further comprising code for quantizing said portion of said plurality of information bits in said received HSDPA bitstream to determine said memory addresses.

14. The machine-readable storage according to claim 11, further comprising code for partitioning processing of said plurality of information bits in said received HSDPA bitstream into a functional data processing path and a functional address processing path.

15. The machine readable storage according to claim 11, wherein said calculation of said memory addresses for said portion of said plurality of information bits comprises at least one of: de-interleaving, bit collection, and de-rate-matching.

16. The machine-readable storage according to claim 15, further comprising code for constellation re-arranging prior to said de-interleaving, if modulation type of said portion of said plurality of information bits is quadrature amplitude modulation (QAM).

17. The machine-readable storage according to claim 15, further comprising code for streaming during said de-rate matching, said portion of said plurality of information bits in said received HSDPA bitstream into at least one of: systematic de-rate matching, parity-1 de-rate matching, and parity-2 de-rate matching based on a bit type associated with said portion of said plurality of information bits in said received HSDPA bitstream.

18. The machine-readable storage according to claim 15, further comprising code for calculating during said de-rate matching, at least one de-rate matching parameter to calculate said memory address of said portion of said plurality of information bits.

19. The machine-readable storage according to claim 11, further comprising code for erasing previously stored data in said IR memory in response to receiving a new portion of said received plurality of information bits.

20. The machine-readable storage according to claim 11, further comprising code for combining previously stored data in said IR memory with said portion of said received plurality of information bits.

21. A system for processing signals in a communication system, the system comprising circuitry that enables mapping of at least a portion of a plurality of information bits in a received HSDPA bitstream to particular memory addresses without buffering said at least portion of said plurality of information bits during hybrid automatic request (HARQ) processing.

22. The system according to claim 21, further comprising circuitry that enables slicing of said portion of said plurality of information bits in said received HSDPA bitstream to determine said memory addresses.

23. The system according to claim 21, further comprising circuitry that enables quantization of said portion of said plurality of information bits in said received HSDPA bitstream to determine said memory addresses.

24. The system according to claim 21, further comprising circuitry that enables partitioning processing of said plurality of information bits in said received HSDPA bitstream into a functional data processing path and a functional address processing path.

25. The system according to claim 1, wherein said calculation of said memory addresses for said portion of said plurality of information bits comprises at least one of: de-interleaving, bit collection, and de-rate-matching.

26. The system according to claim 25, further comprising circuitry that enables constellation re-arrangement prior to said de-interleaving, if modulation type of said portion of said plurality of information bits is quadrature amplitude modulation (QAM).

27. The system according to claim 25, further comprising circuitry that enables streaming during said de-rate matching, said portion of said plurality of information bits in said received HSDPA bitstream into at least one of: systematic de-rate matching, parity-1 de-rate matching, and parity-2 de-rate matching based on a bit type associated with said portion of said plurality of information bits in said received HSDPA bitstream.

28. The system according to claim 25, further comprising circuitry that enables calculation during said de-rate matching, at least one de-rate matching parameter to calculate said memory address of said portion of said plurality of information bits.

29. The system according to claim 21, further comprising circuitry that enables erasing of previously stored data in said IR memory in response to receiving a new portion of said received plurality of information bits.

30. The system according to claim 21, further comprising circuitry that enables combining of previously stored data in said IR memory with said portion of said received plurality of information bits.
